(19) United States
(12) Patent Application Publication
(10) Pub. No.: US 2015/0173074 A1
(43) Pub. Date: Jun. 18, 2015

(54) RANDOM ACCESS IN A COMMUNICATIONS NETWORK

(71) Applicant: TELEFONAKTIEBOLAGET L M ERICSSON (PUBL), Stockholm (SE)

(72) Inventors: Wei Zhao, Stockholm (SE); Pontus Arvidson, Stockholm (SE); Magnus Hurd, Stockholm (SE); Robert Karlsson, Sundbyberg (SE)

(21) Appl. No.: 14/407,851

(22) PCT Filed: Nov. 15, 2012
(86) PCT No.: PCT/EP2012/072800

§ 371 Date: Dec. 12, 2014

Related U.S. Application Data
(60) Provisional application No. 61/660,067, filed on Jun. 15, 2012.

(51) Int. Cl. H04W 72/04; H04W 74/08; H04W 24/08

(52) U.S. Cl. CPC H04W 72/0446; H04W 24/08; H04W 74/0833; H04W 88/08

(57) ABSTRACT

A method and apparatus for dynamically allocating a time delay indicator value and/or random access parameters for sending to a mobile terminal during a Random Access procedure. The time delay indicator value indicates a time delay during which the mobile terminal is restricted from attempting a further Random Access procedure. At least one factor relating to monitored network conditions is determined. The time delay indicator value and/or other random access parameters are allocated on the basis of the factor. The time delay indicator value and/or random access parameters are then sent to the mobile terminal. This ensures that time delay indicator values can be dynamically adjusted depending on network conditions.

### TECHNICAL FIELD

The disclosure relates to the field of Random Access in a communications network, and in particular to Random Access parameters.

### BACKGROUND

In wireless networks, such as Long Term Evolution (LTE), a random access procedure is used to allow a User Equipment (UE) to obtain new or renewed access to the network and to obtain uplink time synchronization. The different purposes for a UE to transmit a random access in LTE are given in Table 1.

TABLE 1
RA transmission purpose
RA Scenario

| | |
|---|---|
| 1 | Initial access from RRC_IDLE |
| 2 | DL data transmission (DL data transmission for a UE in |
| | RRC_CONNECTED that has been set to out-of-synchronization in |
| | the UL requires a random access procedure. The RBS transmits |
| | a Forced UL Synchronization to the UE) |
| 3 | UL data transmission (UL data transmission for a UE in |
| | RRC_CONNECTED that has been set to out-of-synchronization in |
| | the UL requires a random access procedure) |
| 4 | Incoming Handover |

The random access procedure takes two distinct and different forms:
contention based, applicable to all scenarios in Table 1; and
contention free, applicable only to down link (DL) data transmission and incoming handover.

The contention based random access (CBRA) procedure, also termed the general random access procedure, uses any of the preamble sequences that are common to all User Equipment (UEs) and thus requires signalling to resolve any contention that may have occurred. The contention free random access (CFRA) procedure, also termed any of dedicated, non-contention based or contention less random access procedure, uses a preamble sequence that is dedicated for one UE to use.

Regardless of whether the CBRA or CFRA procedure is used, the first two steps of the RA process signalling are highlighted in FIG. 1.

The random access procedure is used to request an initial access for a UE 1 as part of a handover, or to re-establish uplink synchronization. CBRA and CFRA are provided in, for example, a Long Term Evolution (LTE) network. For CBRA, a random access preamble signature is selected at random. In this case, it is possible that more than one UE chooses the same signature, leading to a requirement for subsequent contention resolution. This procedure is applied in all the cases involving the random access. In CFRA, a base station in a LTE Radio Access Network (RAN) 2 (an eNodeB in this example) has the option of preventing contention by allocating a dedicated signature to a UE 1, resulting in contention-free access. CFRA is faster than CBRA. This is particularly important for handover, which is time critical.

In FIG. 1, the first step (MSG1) is the RA preamble, in which the UE 1 indicates to the LTE RAN 2 the presence of a random-access attempt and to allow the LTE RAN 2 to estimate the delay between the LTE RAN 2 and the UE 1.

When a random access preamble is detected by the LTE RAN 2, the LTE RAN 2 prepares and sends a Random Access Response message (MSG2) back to the UE 1. The Random Access Response message may include a Backoff Indicator subheader. Upon receiving the Random Access Response message, if the Backoff Indicator subheader is present, the UE 1 will set the Backoff Indicator value in the UE 1 as indicated by the BI field of the Backoff Indicator subheader and Table 2, as described in 36321-a10, 3GPP; Technical specification group radio access network; evolved universal terrestrial radio access (E-UTRA); Medium Access Control (MAC); protocol specification (Release 10).

TABLE 2
Backoff Indicator Values

| | Backoff Indicator value |
|---|---|
| Index | (ms) |
| 0 | 0 |
| 1 | 10 |
| 2 | 20 |
| 3 | 30 |
| 4 | 40 |
| 5 | 60 |
| 6 | 80 |
| 7 | 120 |
| 8 | 160 |
| 9 | 240 |
| 10 | 320 |
| 11 | 640 |
| 12 | 960 |
| 13 | reserved |
| 14 | reserved |
| 15 | reserved |

The Backoff Indicator provides a means to control the density of random access occurrences during a certain period of time. When a random access procedure fails due to, for example, too high a network load or a bad radio condition, the UE 1 selects a random backoff time according to a uniform distribution between 0 and the Backoff Indicator Value. The UE 1 delays the subsequent Random Access transmission by the backoff time before proceeding to the next round of the random access procedure. Seo, Leung “Design and Analysis of Backoff Algorithms for Random Access Channels in UMTS-LTE and IEEE 802.16 Systems”, IEEE Trans on Veh Tech, vol. 60, no. 8, October 2011 describes algorithms for Random Access Channels.

MSG3 is sent from the UE 1 to the LTE RAN 2. MSG3 indicates an identity, which is echoed in MSG4 sent from the LTE RAN 2 to the UE 1 for contention resolution. In the case where MSG3 is a RRC request, the UE 1 can, for example, indicate a priority of the initial access (for example, an emergency call can be accorded a higher priority). Alternatively, contention resolution message in MSG4 may be to reject the RRC command received in MSG3 with (extended) waiting time.

The Backoff Indicator is meant to give the UE 1 control over how long it should wait before the next random access procedure can start again in the event that the previous random access procedure fails due to, for example, high Random Access Channel (RACH) load, or a bad radio condition. An improper Backoff Indicator value can result in:
Backoff time too short: In this case the UE 1 may re-start a random access procedure too soon after the previous failed random access. This can cause deterioration of conditions on an already highly loaded network, or increase the risk of a failure again because no radio condition improvement has occurred in the short time.
Backoff time too long: In this case the network resource utilization is not optimized and the UE 1 will experience longer delay and interruption time.

In a similar process, access class barring (ACB) is used to prevent congestion of a random access channel in a communications network. Such congestion may be caused by, for example, many devices attempting to access the network at the same time. In ACB, when a random access procedure is initiated by a UE 1, the base station broadcasts an ACB parameter to UEs that it serves. Each UE 1 also draws a pseudo-random number. If the random number is less than the ACB parameter, then the UE 1 continues with the random access procedure. If the random number is greater than the ACB parameter, then the UE 1 is barred from the random access procedure for a barring time duration (a waiting time). The same problems in setting this duration occur as described above for setting a Backoff Indicator value.

### SUMMARY

It is an object to improve the setting of values for Backoff Indicator values, waiting times and extended waiting times.

There is provided a method of dynamically allocating a time delay indicator value and/or random access parameters for sending to a mobile terminal during a Random Access procedure. The time delay indicator value indicates a time delay during which the mobile terminal is restricted from attempting a further Random Access procedure. At least one factor relating to monitored network conditions is determined. The time delay indicator value and/or other random access parameters are allocated on the basis of the factor. The time delay indicator value and/or random access parameters are then sent to the mobile terminal. In an exemplary option, this occurs at a base station. Another way to control the load on the random access channel and on the base station is to adapt ACB parameters. An advantage of this is that time delay indicator values can be dynamically adjusted depending on network conditions. For example, when network conditions are poor, the time delay indicator value may be accorded a high value to reduce the frequency of Random Access attempts from each mobile terminal. When network conditions are good, the time delay indicator value may be accorded a low value to increase the frequency of Random Access attempts from each mobile terminal.

Network conditions may be monitored by a monitoring function at the base station or at another node, and subsequently provided to the base station.

A monitoring function and a determining function as well as allocation of time delay indicators and random access parameters can be located in the base station or in other network elements.

As an option, the time delay indicator value may be selected from a Backoff Indicator value in MSG2. Another option is to select ACB parameters and send them to the mobile terminal. As yet another option, a waiting time or extended waiting time can be used in MSG4 to respond with an RRCConnectionReject to an RRC command received in MSG3. Again, this waiting time or extended waiting time can be set according to monitored network conditions.

As an option, the factor is related to any of
a number of Random Access responses (MSG2) sent;
a number of Random Access scheduled transmissions (MSG3) received;
a number of Physical Random Access Channel scheduling requests;
a number of preambles used;
a number of preambles not used
a number of successful Random Access procedures;
admission control resources available;
a Signalling Radio Bearer load;
a base station processor load;
a base station capacity;
a mobile terminal pre-emption frequency;
a rate of preamble false detections;
a number of preambles sent;
a number of detected contentions;
an estimated number of back-logged mobile terminals;
an estimate rate of capture for Random Access scheduled transmissions (MSG3);
the existence of another ongoing procedure involving the mobile terminal preventing Random Access;

As an option, the base station is an eNodeB and the mobile terminal is a UE. However, it will be appreciated that other types of base station and other types of network may also be used. For example, a similar process may be used for setting ACB parameters in a WCDMA access network.

The principle behind the techniques described herein consists of using existing/new measurement results representing any kind of system load aspect in order to adjust time indicator values such as those mentioned above.

The time delay indicator value is optionally allocated on the basis of any of mapping the factor to a time delay indicator value, performing a threshold comparison of the factor against known factor values, and performing a function on the factor to obtain the time delay indicator value.

According to a second aspect, there is provided a node that is provided with a processor arranged to monitor network conditions, determine a factor based on the monitored network conditions, and determine any of a time delay indicator and parameters. A transmitter is also provided for sending the time delay indicator and/or parameters to specific mobile terminals or to all mobile terminals.

As an option, the processor may monitor network conditions and apply rules or mapping tables to determine the time delay indicator and/or random access parameters. Mapping tables and rules are optionally stored in a database that is stored at a computer readable medium in the form of a memory.

In an optional embodiment, the node is provided with a further In/out device, such as a transceiver or a transmitter and receiver, for obtaining information from other network nodes about network conditions that may be relevant in determining a suitable time delay indicator value.

An example of such as node is a base station. However, it will be appreciated that the node may be remote from a base station. In this case it may send the factor or the time delay indicator value to the base station.

In the case where the node is a base station, it is optionally provided with a receiver for receiving a Random Access preamble from one or more mobile terminals.

According to a third aspect, there is provided a computer program, comprising computer readable code means which, when run from a memory in a processor on a base station, causes the base station server to perform the method described above in the first aspect.

According to a fourth aspect, there is provided a computer program product comprising a computer readable medium and a computer program as described above in the third aspect, wherein the computer program is stored on the computer readable medium.

According to a fifth aspect, there is provided the method as described above in the first aspect, when operated on a vessel or vehicle.

According to a sixth aspect, there is provided the node as described above in the second aspect, when applied to a vessel or vehicle.

### BRIEF DESCRIPTION OF DRAWINGS

FIG. 1 is a signalling diagram showing the first steps of a Random Access Procedure;

FIG. 2 illustrates schematically in a block diagram a way of determining a Backoff Indicator/Waiting Time/Extended Waiting Time/Random Access Parameters using one or more factors;

FIG. 3 is a flow diagram illustrating steps of an exemplary embodiment;

FIG. 4 illustrates schematically in a block diagram a base station according to an exemplary embodiment;

FIG. 5 illustrates schematically in a block diagram an exemplary communications network; and

FIG. 6 illustrates schematically in a block diagram an exemplary vehicle or vessel.

### DETAILED DESCRIPTION

It has been realised that incorrect setting of the Backoff Indicator, ACB waiting parameters, or other time delay indicator values for radio access can lead to problems in the network.

It has been realised that by dynamically adjusting the Backoff Indicator values and adapting them to prevailing network conditions allows for much better control of the load on the random access channel and the load in the base station. Note that the Backoff Indicator value is sent in a subheader from the eNodeB 2 to the UE 1, and the UE 1 uses the Backoff Indicator value as a backoff parameter.

The description below refers to setting a value for a Backoff Indicator by way of example. However, it will be appreciated that other durations for setting a delay period during which a mobile terminal cannot attempt Random Access can be determined in a similar way. For example, where a Backoff Indicator is referred to below, it will be appreciated that similar techniques may apply to obtaining an ACB barring time for an ACB procedure or (extended) waiting time in a MSG4 carrying an RRC Reject in response to an RRC message received in MSG3. A waiting time is set during a connection request procedure when a negative response is sent to the request. Note that a waiting time is set on another Layer (Layer 3) to a Backoff Indicator (Layer 2). Again, this (extended) waiting time can be set according to monitored network conditions. The techniques described below apply to any time delay indicator value indicating a time during which a mobile terminal cannot attempt Random Access.

Certain factors can be used combined or separately as input to obtain a suitable time delay indicator value. The same set of factors can also be used to adjust, for example, access class barring which provides a more coarse and long-term effect for RA load control. Potential limiting factors can be categorized as, but are not limited to:
RA MSG2. This is the first response from the eNB 2 to the UE 1. The eNB 2 may have limited processing capacity in order to create the MSG2 response.
RA MSG3. In this case, the eNB 2 has limited processing capacity in order to detect and handle the MSG 3 message. This is similar tot he example above, in that the eNB 2 has limited processing capabilities that might be exceeding at times of high load.
Scheduling requests on a Physical Random Access Channel (PRACH). If the scheduling request resource is over-allocated, each UE 1 may not be properly served.
PRACH Load/Interference. Interference is where many UEs use the same preambles. If the eNB 2 is overloaded, then it is less accurate in identifying RA attempts.
Preambles used.
Preambles not used: these can be used as an indication of how much RA load the networking is handling. Since there are 64 preambles, preambles used and preambles not used can be considered to be the same criteria.
RA success rate. If there are many unsuccessful Random Access attempts, this suggests that the network may be overloaded.
Admission Control. If system resources managed by admission control are congested, it is reasonable to lower RA frequency since the prospect of a successful RA procedure is low in any case.
Signalling Radio Bearer (SRB) load. Random Access generates signalling. A high SRB load can starve out Data Radio Bearers (DRBs), and so this may be an indication that there are many unsuccessful RA attempts.
Main Processor Load (limited eNB 2 processing capacity for handling Radio resource Control (RRC), S1AP/X2AP procedures)
UE 1 pre-emption frequency. This is related to admission control. If UEs are being removed from the network, then there is little point in admitting new UEs. If a frequency of UE 1 pre-emption increases, an increased number of RA attempts are expected, or more generally when the frequency of eNB-initiated UE releases increases.
Rate of preamble false detections. This may be estimated, for example, by a rate of MSG3 failures, when a detection is made that there is no signal energy where a MSG3 is expected. Many ‘false alarms’ for expected MSG3 indicates how many MSG3 messages have failed.
Number of preambles sent by one or more UEs (as reported by the UE 1 information response). If, for example, one UE is sending more preambles than other UEs, then it is taking a disproportionate share of resources. It is reasonable in this case to set a high time delay indicator for that UE in order to reduce the number of preambles that it sends.
Number of detected contentions (as reported by the UE 1 information response). In this case, at least two UEs are using the same preamble. This suggests a heavy load on the network.
Estimated number of back-logged UEs (for example by counting the number of estimated collisions of MSG3 (where received energy is high but many re-transmissions are required) and/or rate of RRC Connection Reject due to processing capacity and/or rate of RRC reestablishment rejects). This occurs in the case where more than one UE successfully uses the same preamble.
Estimated rate of capture for MSG3 (estimation of rate when there is a collision of MSG3 but one of them is detected anyway).
There is any reason that the request cannot be executed because of e.g. other ongoing procedures with respect to the UE.

Note that the above is a non-exhaustive list, and other factors may be included if the are relevant to setting a suitable time delay indicator value. All of these factors may be considered broadly to be related to network conditions in some way, or any kind of rules that represent an order in which the in which the eNB 2 can serve requests.

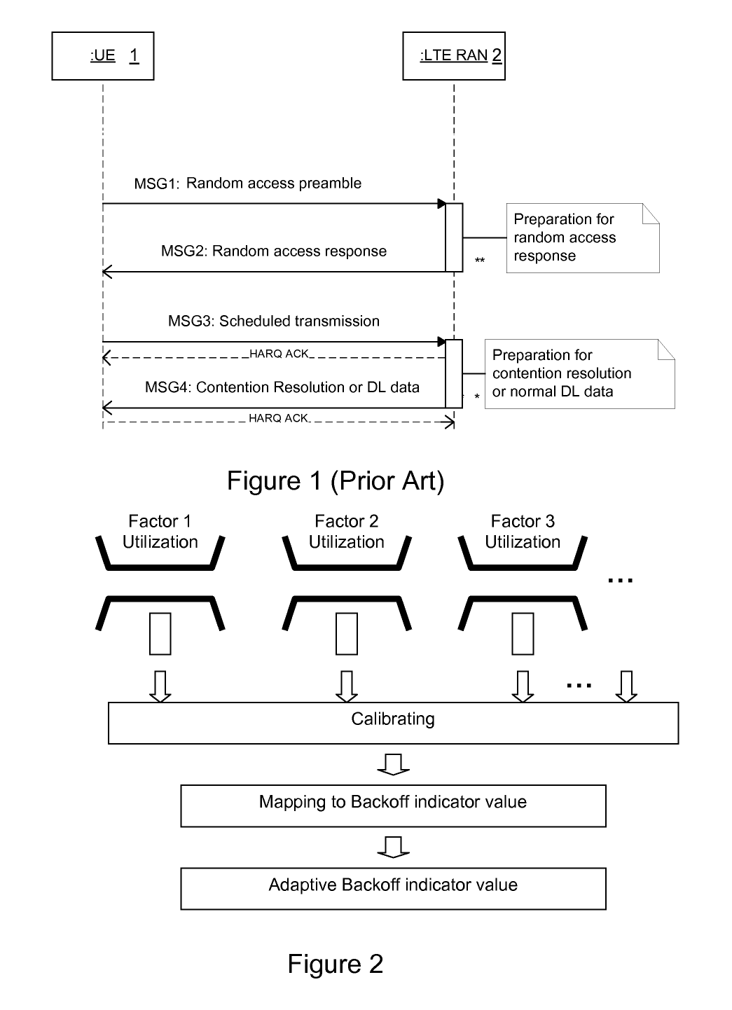

A network node measures and monitors one or several of the abovementioned factors, and computes a time delay indicator value (such as a Backoff Indicator value and/or AC barring time and/or Waiting Time and/or Extended Waiting Time or random access parameters). The time delay indicator value is used in MSG2 and/or MSG4 shown in FIG. 1 and sent to the UE 1. The UE 1 uses the time delay indicator value to determine a time when it can next attempt a Random Access procedure.

Examples of ways to compute a time delay indicator value include using a mapping table, a threshold comparison or any general function taking these system measures as input to compute time delay indicator value. The computed result provides a time delay indicator value that reflects the network load, radio conditions and other network resource utilizations, as illustrated in FIG. 2.

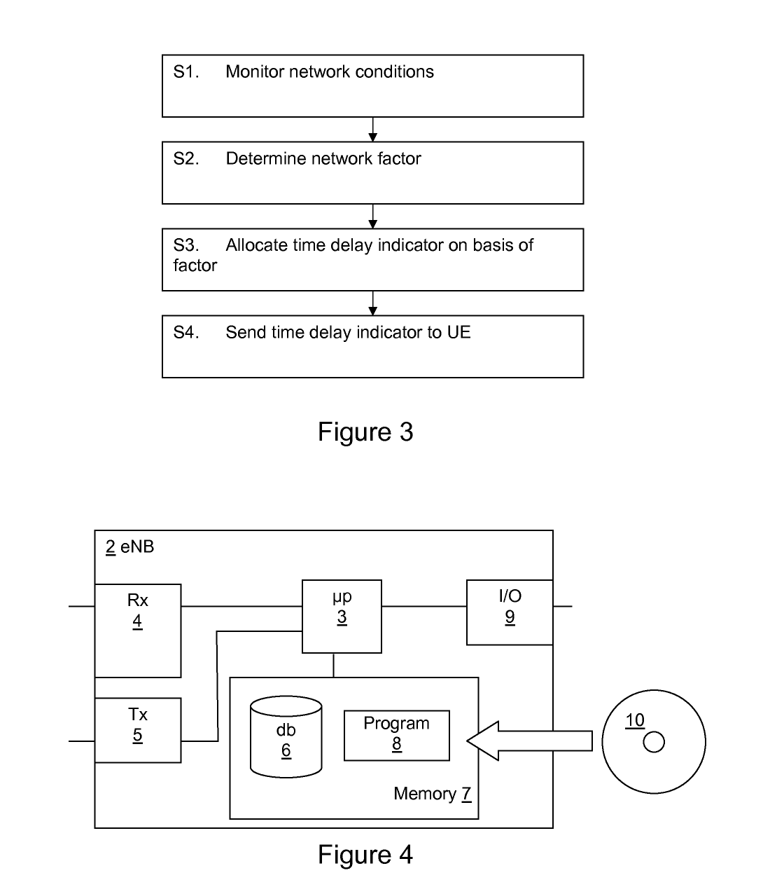

In the example of FIG. 2, three utilisation factors are illustrated. These factors are monitored and measured, and calibrated. They are then used to map to a time delay indicator value (a Backoff indicator value in the example of FIG. 3).

FIG. 3 is a flow diagram illustrating steps of an embodiment. The following numbering corresponds to that of FIG. 3:

S1. Network conditions are monitored, either by the eNodeB 2 or by another node that can send information about the network conditions to the eNodeB 2. Examples of the types of network condition that may be monitored are provided above.

S2. The monitored network conditions are used to determine a network factor, either in the eNodeB 2 or by another node that can send information to the eNodeB 2, which relates to the monitored network conditions.

S3. A time delay indicator value, such as a Backoff Indicator value, an AC barring time or a Waiting Time or an Extended Waiting Time or random access parameter, is determined on the basis of the network factor (or more than one network factor).

S4. The time delay indicator value or random access parameter is sent to the UE 1 as part of a Random Access procedure, typically in message MSG2 or MSG4. Alternatively, this may be sent in a dedicated UE 1 message or in a broadcast message to all UEs.

It will be appreciated that monitoring network conditions allows the time delay indicator value and random access parameters to be allocated dynamically. This makes the time delay indicator value much more suitable for use by the UE 1 depending on prevailing conditions. For example, a time delay indicator value sent to a UE 1 during times of high network congestion may differ significantly from a time delay indicator value sent to the same UE 1 during times of low network congestion.

Referring now to FIG. 4, there is illustrated an embodiment in which all the functions described above are located in a base station 2 such as an eNodeB. Note, however, that different functions may be located in different nodes, and so the base station 2 is illustrated by way of example only.

The base station 2 is provided with a processor 3. A receiver 4 is provided for receiving a Random Access preamble (MSG1) from one or more UEs 1. The processor 3 determines a time delay indicator as described above and sends it to the UE using a transmitter 5. The processor 3 may monitor network conditions and apply rules or mapping tables to determine the time delay indicator. Mapping tables and rules can be stored in a database 6 that is stored at a computer readable medium in the form of a memory 7. The memory 7 may also be used to store a computer program 8 that, when executed by the processor 3, causes the processor 3 to perform the methods described above.

In an optional embodiment, the base station 2 may be provided with a further In/out device 9, such as a transceiver or a transmitter and receiver, for obtaining information from other network nodes about network conditions that may be relevant in determining a suitable time delay indicator value.

The computer program 8 may be initially stored on an external medium 10, and loaded into the memory 7 for execution by the processor 3, or executed directly from the external medium 10.

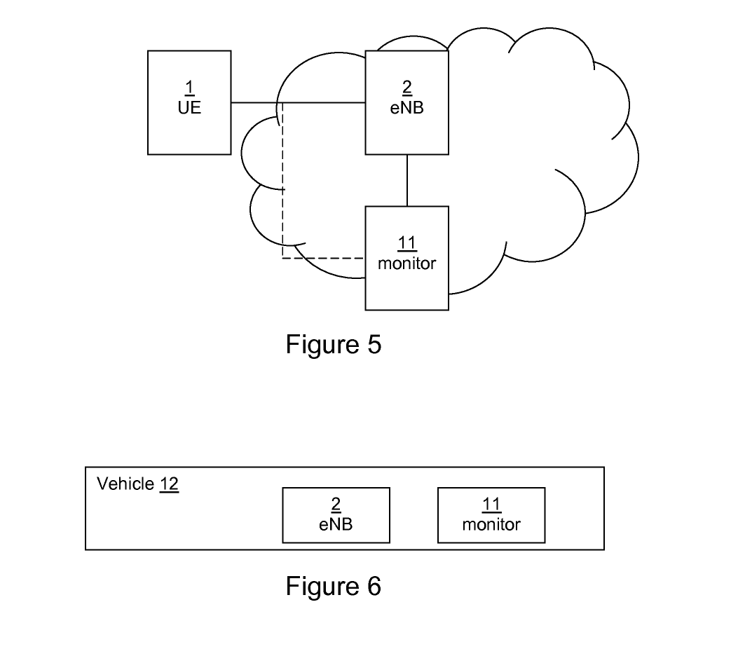

A further exemplary embodiment is illustrated in FIG. 5, in which a monitoring node 11 monitors network conditions and provides information to the base station 2. In this case, the monitoring node 11 may provide network condition factors to the base station 2, allowing the base station 2 to calculate a suitable time delay indicator value. Alternatively, the monitoring node 11 may calculate the time delay indicator value and send it to the base station 2. In either case, the monitoring node 11 and the base station 2 require an interface. An advantage of using a monitoring node is that the additional processing and other resource requirements of the base station are minimized.

As described above, there are many different factors that can be used to compute a suitable time delay indicator value and random access parameters, and so some examples are given below by way of illustration:

### EXAMPLE 1

### Backoff Indicator Adjustment Based on Random Access Related Factors

In this example, the following random access related factors will be examined and used as input for backoff indicator adjustment:

RA MSG2:

During a measurement period, the number of RA MSG2 scheduled to different UEs can be collected for each Transmission Time Interval (TTI). Two possible load metrics L₁ and L₂ can be defined for this factor:

$${L}_{1} = \frac{TotalRAMSG 2 Scheduled}{MaxRAMSG 2 Capacity} , \\ and$$

$${L}_{2} = \frac{NumberofMaxRaMsg 2 SchedulingCapacityTTI}{TotalTTI}$$

L₁ represents the number of scheduled RA MSG2s compared with the maximum RA MSG2 scheduling capacity, while L₂ indicates the percentage of TTIs where max RA MSG2 scheduling capacity is used versus the total number of TTIs during a measurement period. During a measurement period, a performance counter can be incremented at each TTI when the number of scheduled RA MSG2 is equal to the maximum number of scheduled RA MSG2 allowed by the system. At the end of the measurement period this counter can be compared against the total number of TTIs in this measurement period and get a value for L₂. These two metrics combined together give a good picture of the overall RA MSG2 load as well as the “burstiness” of RA MSG2 scheduling. When one or both metrics exceed/drop below predefined threshold values, an adjustment to the Backoff Indicator may be needed to slow down or speed up the number of UEs attempting random access.

Preamble Used:

The number of preambles can be defined as Np and are used during a measurement period to indicate RA resource utilization. When Np exceeds a threshold, an action may be needed, but typically this factor should be combined with e.g. RA MSG2 or other factors instead of being used alone for Backoff Indicator adjustment.

RA Success Rate:

RA success rate S_{RA} can be defined as the number of successful random access versus the total number of RA attempts. A low RA success rate can either be caused by too many UEs trying to attempt random access at the same time, or a number of UEs with bad radio conditions attempting constantly without a success. The RA success rate combined with RA MSG2 can distinguish network load situation from bad radio condition, e.g. high RA MSG2 utilization plus low RA success rate indicates high RA load, while low RA MSG2 utilization plus low RA success rate indicates bad radio conditions for a number of UEs.

Measure results from the abovementioned factors can be calibrated further by e.g. weight based calculation, such as:

$$W = {W}_{1} * {T}_{1} + {W}_{2} * {T}_{2} + {W}_{3} * {T}_{3}$$

$$where$$

$$\begin{matrix}{T}_{1} = \{ \begin{matrix}1 \\ 0\end{matrix} & \begin{matrix}\begin{matrix}When {L}_{1} * {L}_{2} > {L}_{T 1} * {L}_{T 2} , With {L}_{T 1} and \\ {L}_{T 2} being thresholds for {L}_{1} and {L}_{2} respectively .\end{matrix} \\ Otherwise\end{matrix} \\ {T}_{2} = \{ \begin{matrix}1 \\ 0\end{matrix} & \begin{matrix}\begin{matrix}When {N}_{p} * {L}_{1} * {L}_{2} > {L}_{T 1} * {L}_{T 2} , With Nt , {L}_{T 1} and \\ {L}_{T 2} being thresholds for {N}_{p} , {L}_{1} and {L}_{2} respectively .\end{matrix} \\ Otherwise\end{matrix} \\ {T}_{3} = \{ \begin{matrix}1 \\ 0\end{matrix} & \begin{matrix}When {S}_{RA} < {S}_{t} and {L}_{2} > {L}_{T 2} \\ Otherwise\end{matrix} .\end{matrix}$$

The output of the calibration can be used as input for adaptive Backoff Indicator adjustment.

### EXAMPLE 2

### Backoff Indicator Adjustment Based on Admission Control Related Factors

As admission control has the objective of keeping the system load at a level that the system can handle, the behaviour of admission control may also be used as an indicator that shows if the system could benefit from decreasing the load on the random access channel.

For instance, if a very large percentage of initial access attempts are blocked by admission control due to lack of system resources it may be wise to increase the time delay indicator value to reduce the load at an even earlier stage.

Another application is to relate the time delay indicator value to eNB-initiated release frequency (the frequency with which the eNB 2 releases a UE), since it is likely that these released UEs can be expected to attempt RA a further time.

Referring now to FIG. 6, there is illustrated a vehicle or vessel 12 comprising a monitoring node 10 and/or a base station 2 as described above. Examples of vessels and vehicles include, but are not limited to, trains, ships, trucks, aeroplanes and so on.

In order to implement the adaptive Backoff Indicator and ACB barring parameters and Waiting Time and Extended Waiting Time adjustments, certain factors must be considered. Some impacting factors for adaptive Backoff Indicator and ACB barring parameters and Waiting Time and Extended Waiting Time adjustment are based on existing measurements, such as RA success rate, number of preambles used, resources used for SRBs, etc, while others need new performance counters to collect the necessary information. From an implementation perspective, it is a matter of using the existing/new measurement results representing any kind of system load aspect in a new way, i.e. to adjust Backoff Indicator. After the Backoff Indicator value is changed, it will be included in the next RA MSG2.

Adaptive Backoff Indicator adjustment provides a means to adjust the Backoff Indicator value based on network load and radio condition, which in turn controls the resource request behaviour. It smoothes out the load on the resource by instructing a mobile terminal such as a UE to wait for a longer time before making further requests during high load, while when the situation improves it can encourage requests to occur with shorter time interval, which improves and optimizes network resource utilization.

It will be appreciated by the person of skill in the art that various modifications may be made to the above described embodiment without departing from the scope of the present disclosure. For example, the functions of the network node are described as being embodied at a single node, but it will be appreciated that different functions may be provided at different network nodes. Furthermore, the description above assumes a UE and an eNB are the mobile terminal and the base station, but it will be appreciated that the same techniques can be used in any type of communications access network.

The following acronyms have been used in the above description:

ACB access class barring

CBRA contention based random access

CFRA contention free random access

DL downlink

DRB Data Radio Bearers

eNB eNodeB

LTE Long Term Evolution

PRACH Physical Random Access Channel

RA Random Access

RACH Random Access Channel

RAN Radio Access Network

RRC Radio resource Control

SRB Signalling Radio Bearer

TTI Transmission Time Interval

UE User Equipment

UL uplink

WCDMA Wideband Code Division Multiple Access

1. A method of dynamically allocating a time delay indicator value and/or a random access parameter for sending to a mobile terminal during a Random Access procedure, the method comprising, at a node in a communications network:
monitoring at least one network condition;
determining at least one factor value relating to the at least one monitored network condition;
allocating the time delay indicator value and/or the random access parameter on the basis of the at least one factor value; and
sending the time delay indicator value and/or random access parameter to the mobile terminal.

2. The method according to claim 1, wherein the node is a base station.

3. The method according to claim 1, wherein the node is a monitoring node, the method further comprising sending any of the monitored network conditions, the at least one factor value, and the time delay indicator value to a base station.

4. The method according to claim 1, wherein the random access parameter comprises an access class barring parameter.

5. The method according to claim 1, wherein the time delay indicator value comprises any of a Backoff Indicator value, a waiting time, and an extended waiting time.

6. The method according to claim 1, wherein the at least one factor value is related to any of:
a number of Random Access responses sent;
a number of Random Access scheduled transmissions received;
a number of Physical Random Access Channel scheduling requests;
a number of preambles used;
a number of preambles not used;
a number of successful Random Access procedures;
admission control resources available;
a Signalling Radio Bearer load;
a base station processor load;
a base station capacity;
a mobile terminal pre-emption frequency;
a rate of preamble false detections;
a number of preambles sent;
a number of detected contentions;
an estimated number of back-logged mobile terminals;
an estimate rate of capture for Random Access scheduled transmissions; and
the existence of another ongoing procedure involving the mobile terminal preventing Random Access.

7. The method according to claim 1, wherein the base station is an eNodeB and the mobile terminal is a User Equipment.

8. The method according to claim 1, further comprising allocating the time delay indicator value by any of:
mapping the at least one factor value to a time delay indicator value;
performing a threshold comparison of the at least one factor value against known factor values; and
performing a function on the at least one factor value to obtain the time delay indicator value.

9. A node for use in a communication network, the node comprising:
a processor arranged to monitor at least one network condition;
the processor being further arranged to determine at least one factor value relating to the at least one monitored network condition;
the processor being further arranged to allocate the time delay indicator value and/or the random access parameter on the basis of the at least one factor value; and
a transmitter for sending the time delay indicator value and/or random access parameter towards a mobile terminal.

10. The node according to claim 9, further comprising a database arranged to store any of rules and mapping tables for use by the processor to determine the time delay indicator and/or random access parameters.

11. The node according to claim 9, further comprising an in/out device for obtaining information from other network nodes about network conditions.

12. The node according to claim 9, wherein the node is a base station.

13. The node according to claim 12, further comprising a receiver for receiving a Random Access preamble from one or more mobile terminals.

14. The node according to claim 9, further comprising an in/out device for sending to a base station any of information relating to a monitored network condition, a factor value relating to a monitored network condition, and the time delay indicator value and/or the random access parameter.

15. A computer program comprising computer readable code which, when run from a non-transitory computer readable medium in the form of a memory by a processor on a node, causes the node to perform the method as claimed in claim 1.

16. A computer program product comprising a non-transitory computer readable medium and a computer program as claimed in claim 14, wherein the computer program is stored on the computer readable medium.

17. The method according to claim 1, wherein the method is operated on a vessel or vehicle.

18. The node according to claim 9, wherein the node is included in a vessel or vehicle.
